(19) United States
(12) Patent Application Publication
(10) Pub. No.: US 2006/0251087 A1
(43) Pub. Date: Nov. 9, 2006

(54) Processing an information payload in a communication interface

(76) Inventors: WeiLoon Ng, Singapore (SG); Wesley WingHung Chan, Singapore (SG); YamPheng Tham, Singapore (SG); CheeSeng Toh, Singapore (SG); YongPeng Chng, Singapore (SG); ChweeFern Ee, Singapore (SG)

Correspondence Address: H. Sanders Gwin, Jr.;Shumaker & Sieffert, P.A., Suite 105, 8425 Seasons Parkway, St. Paul, MN, 55125, US

(21) Appl. No.: 11/120,667

(22) Filed: May 3, 2005

(51) Int. Cl. H04L 12/56; H04L 12/28

(52) U.S. Cl. 370/401

(57) ABSTRACT

In one illustrative example, a bridge connecting a universal serial bus (USB) interface and an advanced technology attachment (ATA) interface may decode a customized small computer system interface (SCSI) command to enable the system to send ATA commands over the USB interface. A customized SCSI command may implement a “pass-through” feature that allows the system to support logical block addresses (LBA) of 48 or more bits, and Self-Monitoring and Reporting Technology (SMART) commands associated with a hard disc drive (HDD). In conjunction with the bridge, the system may send an ATA-command payload, within a wrapper. The bridge may remove the wrapper without substantially altering the payload, and send the ATA-command payload over the ATA bus.

### FIELD OF THE DISCLOSURE

This disclosure relates to processing an information payload in a communication interface.

### BACKGROUND

Some electronic devices communicate with other electronic devices by exchanging digitally-encoded information through a communication interface. In one example, a computer system may communicate through a communication interface to transfer information to or from a mass storage device. One type of mass storage device is a hard disc drive (HDD). A HDD may include physical media on which information may be stored, for example, in magnetic form.

Various communication interfaces, each with a particular protocol, may be used to communicate information between different electronic devices, such as mass storage devices and computers. One such communication interface is an advanced technology attachment (ATA) bus. A universal serial bus (USB) is also commonly used in some computers and other electronic devices. Another communication interface that is common in computers is a small computer system interface (SCSI).

An ATA bus is commonly used to connect a computer device and a mass storage device such as, for example, a HDD, a CD-ROM device, or a tape device. For example, an ATA bus allows a computer to use a common cable, connector set, protocol, and command set to communicate with ATA-configured mass storage devices.

USB interfaces are commonly used to connect a computer device and one or more peripheral devices such as, for example, a keyboard or mouse, printers, scanners, digital cameras, or external mass storage devices. In many applications, a USB interface provides a means for connecting peripheral devices to a computer without powering down the computer, with little or no software configuration, and with few limitations as to the number of other peripheral devices that may be simultaneously connected to the computer.

A SCSI bus is commonly used to connect an enterprise server to one or more HDDs. In many applications, a server architecture may benefit from longer cable lengths and additional addressing capabilities of SCSI. Many applications also benefit from a common cable and connector set, protocol and command set to connect to SCSI-configured mass storage devices. Some SCSI commands are also used by some other communication interfaces, such as, for example, some USB interfaces.

In some cases, different communication interfaces may be able to communicate by transferring packets of information through a bridge device. In such cases, a bridge may enable certain information to be exchanged, even though each communication interface uses a different protocol.

### SUMMARY

In a bridge between a first bus and a second bus, a method and associated apparatus for processing a packet of information includes receiving from the first bus the packet of information containing a “wrapper,” an operations code (opcode), and an information payload, separating the wrapper from the information payload and identifying the opcode, and sending the information payload over the second bus without substantial alteration if the identified opcode is a predetermined opcode. The information payload may have more than ten bytes and be in a format compatible with the second bus.

In one illustrative example, a bridge connecting a universal serial bus (USB) interface and an advanced technology attachment (ATA) interface may decode a customized small computer system interface (SCSI) command to enable the system to send ATA commands over the USB interface. A customized SCSI command may implement a “pass-through” feature that allows the system to support logical block addresses (LBA) of 48 or more bits, and Self-Monitoring and Reporting Technology (SMART) commands associated with a hard disc drive (HDD). The customized SCSI command may be associated with a predetermined opcode. In conjunction with the bridge, the system may send an ATA-command payload, within a wrapper. The bridge may remove the wrapper without substantially altering the payload, and send the ATA-command payload over the ATA bus.

Various embodiments may have one or more advantages. For example, sending an ATA command over a USB interface within a SCSI command wrapper may extend functionality of an existing system, protocol, or command. A customized SCSI command may support larger addresses than may be characterized in recent versions of ATA. A customized SCSI command may further support particular ATA features, such as Self-Monitoring Analysis and Reporting Technology (SMART) and up to 48-bit logical block addressing (LBA). Development time and cost reductions may be realized while providing extended functionality and performance capabilities using expanded protocols and commands.

The details of one or more embodiments are set forth in the accompanying drawings and the description below. Other features, objects, and advantages will be apparent from the description and drawings, and from the claims.

### DESCRIPTION OF DRAWINGS

FIG. 1 is a diagram of an exemplary system in which information payloads may be processed in a communication interface.

FIG. 2 is a diagram of an exemplary command block wrapper that may be transmitted over a USB interface.

FIG. 3 is a diagram of an exemplary status communication that may be sent over a USB interface.

FIG. 4A is a diagram showing an exemplary custom SCSI command.

FIG. 4B is a diagram showing an exemplary ATA command.

FIG. 5A is a flow diagram illustrating a method for processing an information payload, according to one embodiment.

Like reference symbols in the various drawings indicate like elements.

### DETAILED DESCRIPTION OF EXEMPLARY EMBODIMENTS

In some embodiments, a communication interface may comprise a universal serial bus (USB) interface, a bridge, and an advanced technology attachment (ATA) interface. The USB interface may use a protocol and command set similar to those used by a small computer system interface (SCSI). The bridge may process information payloads passing between the USB and ATA interfaces. For example, the bridge may permit ATA commands to be sent directly over the USB interface. A customized SCSI command may facilitate one method of sending ATA commands over the USB interface. The customized SCSI command may transport an ATA command to a bridge, and the bridge may extract the ATA command portion and send it over the ATA interface.

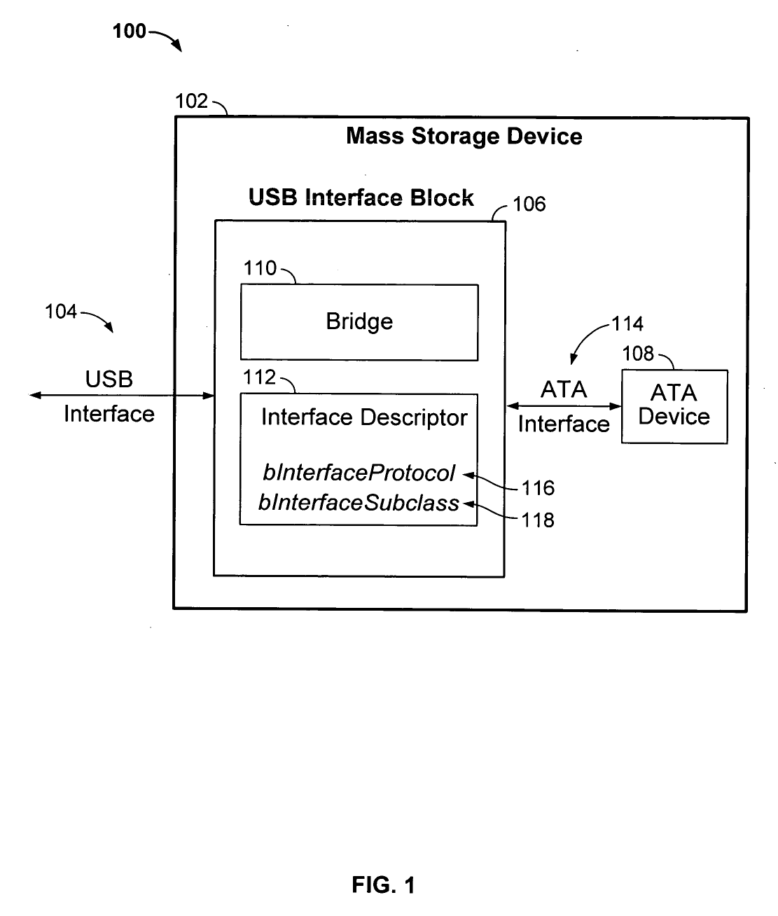

FIG. 1 is a diagram of an exemplary system 100 in which information payloads may be processed in a communication interface. More particularly, ATA command payloads may be processed in the system 100. In the system 100, a mass storage device 102 includes a USB interface 104 and an ATA device 108. The ATA device 108 could be, for example, an ATA hard disc drive (HDD).

The USB interface 104 may follow conventions outlined in Universal Serial Bus Mass Storage Class Specification Overview, revision 1.2, Jun. 23, 2003. This document is publicly available from http://www.usb.org. The USB interface 104 may connect to another device (not shown) such as, for example, a computer device or a camera device.

The storage device 102 further includes a USB interface block 106, which includes a bridge 110 and an Interface Descriptor 112. The bridge 110 couples the USB interface 104 to the ATA device 108 via an ATA interface 114. Functionally, the bridge 110 may receive data in USB-compatible format from the USB interface 104; process it, for example to convert it to an ATA-compatible format; and transmit the data over the ATA interface 114. Similarly, the bridge 110 may receive data in an ATA-compatible format from the ATA interface 114, convert it to a USB-compatible format, and transmit the data over the USB interface 104.

The format of data in either the USB interface 104 or in the ATA interface 114 may be characterized by a predefined protocol and by a predefined set of commands. For example, the aforementioned Universal Serial Bus Mass Storage Class Specification Overview describes an Interface Descriptor that includes several parameters that may relate to various aspects of a particular interface. Two such parameters are depicted in FIG. 1 as fields bInterfaceProtocol 116 and bInterfaceSubClass 118. The field bInterfaceProtocol 116 may reference a predefined protocol for the USB interface 104, such as, for example, a “Bulk-Only Transport” (BOT) protocol. Aspects of the Bulk-Only Transport protocol are described in the document Universal Serial Bus Mass Storage Class Bulk-Only Transport, Revision 1.0, Sep. 31, 1999. This document is publicly available from http://www.usb.org. The field bInterfaceSubClass 118 may reference a particular set of commands for the interface, such as, for example, “SCSI Transparent Commands,” a format which may be described in part in the document Information technology—SCSI Primary Commands—2 (SPC-2), Revision 20, Jul. 18, 2001. This document is publicly available from http://www.t10.org.

In general, buses such as USB may transport messages among two or more electronic devices. In some implementations, the messages are formatted into packets of information for transport over an information channel coupled to a communication interface. The information packets may be transported, for example, from a source to at least one destination. In some implementations, an information packet includes an information payload and a “wrapper.”

In various implementations, the information payload in an information packet may include address, data, control, command, programming, status, metadata, or other information. Metadata may include information about other information, and in particular examples, metadata may relate to the intended use or application of a particular information payload. In some examples, the information payload may relate to the operation of one or more electronic devices with communication interfaces. As for one example, an information payload may relate to one or more operations for storing or retrieving information from a particular ATA device. References herein to a particular command payload may refer to an information payload that may contain command or other information.

In some embodiments, the “wrapper” in an information packet may include one or more types of information associated with the information payload. The wrapper may contain, but is not limited to, the following types of information: source address, destination address, control, status, time stamp, network routing, priority, encryption, error detection, error correction, size, or other information related to the transport or content of the information payload. The wrapper may be formatted as a header, footer, or may otherwise be integrated with the information payload in an information packet. For one example, a wrapper formatted in compliance with the Bulk-Only Transport (BOT) protocol specification may be used to wrap an information payload into an information packet for transport over a USB physical bus.

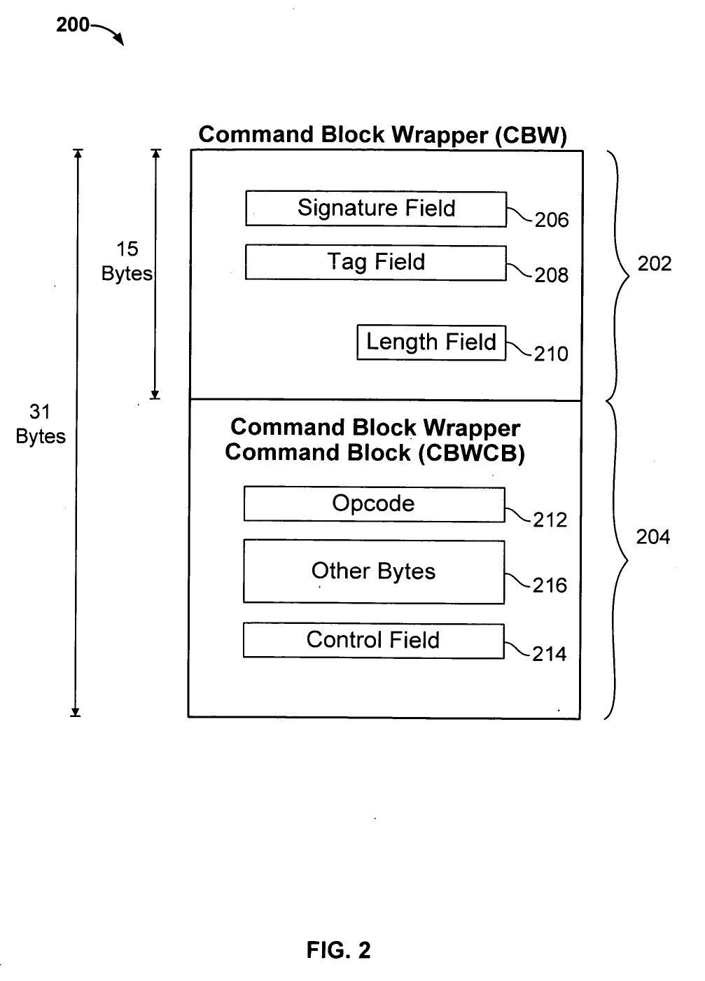

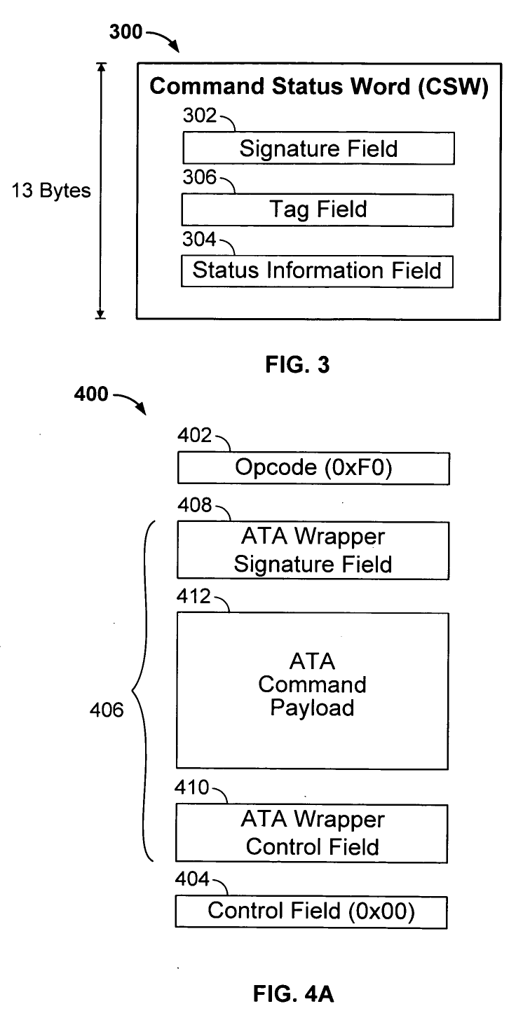

An exemplary packet of information that may be transmitted over the USB interface 104 is a command block wrapper (CBW) 200, as shown in FIG. 2. In this example, the CBW 200 comprises 31 bytes of data which comprise two portions: a header portion 202 and a payload portion 204. The header portion comprises a signature field 206, a tag field 208, and a length field 210. The signature field 206 may indicate that the CBW is a BOT-protocol CBW 200. The tag field 208 may be used to track a specific command included in the CBW 200. For example, a follow-up status communication may include the identifier included in the tag field 208, as will be described in more detail with reference to FIG. 3. The length field 210 may specify a length for data included in the payload portion 204. Although the overall size of the CBW 200 of this example is fixed at 31 bytes, the payload portion 204 may be of variable length. For example, the payload portion 204 may include a 6-byte command, a 10-byte command, a 12-byte command, or a command of some other length equal-to or less-than 16-bytes. The length field 210 may differentiate commands of different lengths. The payload portion 204 may comprise data other than commands, as well.

A command may comprise an operation code (opcode) 212 and a control field 214. The opcode 212 may comprise one byte of data that uniquely identifies a particular operation. The control field 214 may provide additional control for the particular operation identified by the opcode 212. Other bytes 216 may provide additional parameters for the operation identified by the opcode. For example, if the opcode 212 specifies a read data command, the other bytes 216 may provide a device identifier and address from which data should be read.

Opcodes and corresponding commands that may be included in the CBW 200 of this example may be described in the document SCSI-3 Block Commands (SBC), Revision 8c, Nov. 13, 1997. This document is publicly available from http://www.t10.org. Exemplary command opcodes may comprise eight bits. As described in the SCSI-3 Block Commands (SBC) document, some commands may be available as vendor-specific commands. For example, as described in the SBC, as of its noted publication date, commands between 0×C0 and 0×FF may be available as vendor-specific commands and may be used to create “custom” commands. Over time, the characterization of some of vendor-specific commands may enjoy widespread acceptance—to the extent that they become de facto “standard” commands. De facto standard commands may be incorporated into a future revision of the SBC or into some other document that characterizes SCSI commands.

FIG. 3 shows a command status word (CSW) 300, which is an exemplary status communication that may be sent over the USB interface 104 in an implementation that utilizes the Bulk-Only Transport (BOT) protocol. The CSW 300 may be sent, for example, by the bridge 110 (FIG. 1) in response to the CBW 200.

As shown, the CSW 300 comprises 13 bytes of data and a number of fields. For example, the CSW 300 includes a signature field 302, a status information field 304, and a tag field 306. The signature field 302 may indicate that the communication is a BOT-protocol CSW 300. The status information field 306 may indicate a result associated with a previous command. For example, the status information field 306 may indicate whether a previous command, such as a command included in the payload portion 204 of the CBW 200, executed successfully. The tag field 304 may be an identifier that links the CSW 300 to the CBW 200 for which status is being reported. If the command included in the CBW 200 failed, the status information field 306 may also include information about the failure.

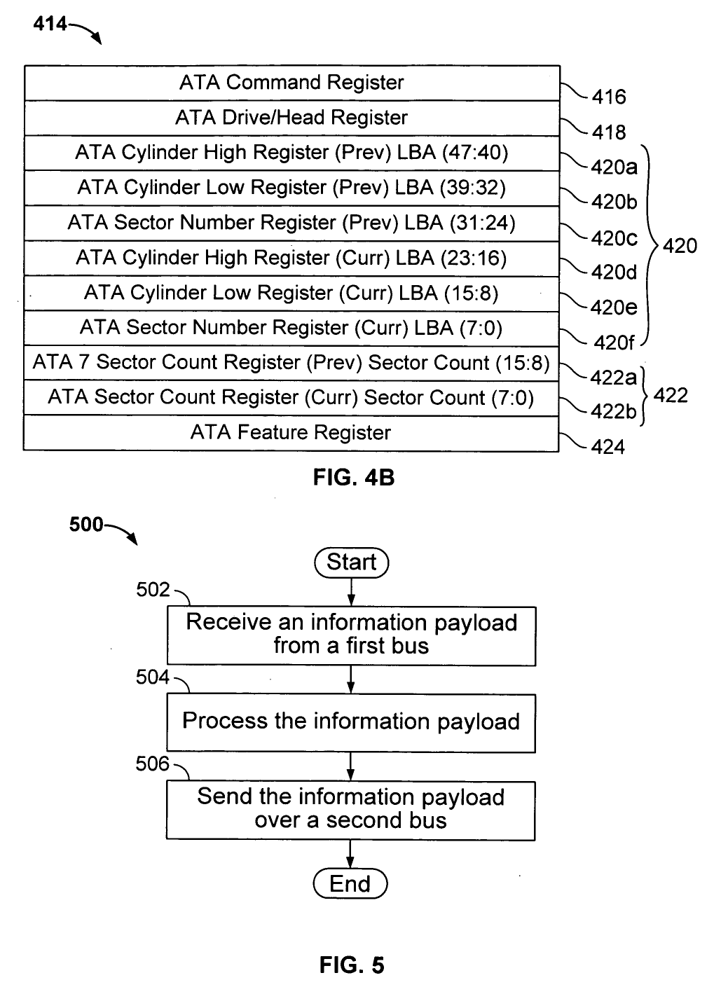

FIG. 4A is a diagram showing structure of an exemplary “custom” SCSI command 400. As shown, the command 400 includes an opcode 402—shown as having a value of 0×F0. The command 400 also includes a control field 404—shown as having a value of 0×00. Between the opcode 402 and the control field 404 are other parameters 406 of the command 400. As shown, the other parameters 406 include an ATA wrapper signature field 408, an ATA wrapper control field 410, and an ATA command payload 412. The ATA command payload 412 may include parameters necessary to execute commands in the ATA device, such as the ATA device 108. For example, in a read command, the ATA command payload 412 may include an address from which data should be read. The ATA wrapper signature field 408 and the ATA wrapper control field 410 may allow a device that processes the custom command 400 to identify and extract the ATA command payload 412.

FIG. 4B is a diagram showing an exemplary ATA command 414. The exemplary ATA command 414 may be included, for example, in the ATA command payload 412 of the custom SCSI command 400. As shown, the ATA command 414 comprises a number of fields, including a one-byte ATA command register field 416, a one-byte ATA drive/head register field 418, a 48-bit (six-byte) ATA address field 420 (“LBA48 address field 420”), a two-byte ATA Sector Count Register 422, and a one-byte ATA Feature Register 424. As shown, the LBA48 address field 420 comprises “previous” values for each of an ATA Cylinder High Register 420a, an ATA Cylinder Low Register 420b, and an ATA Sector Number Register 420c. The LBA48 address field 420 also comprises fields with “current” values of the above registers, including an ATA Cylinder High Register 420d, an ATA Cylinder Low Register 420e, and an ATA Sector Number Register 420f. The ATA Sector Count Register 422 comprises a previous value 422a and a current value 422b. The previous and current values of each of the above registers may be concatenated to create two-byte values for each of ATA Cylinder High, ATA Cylinder Low, and ATA Sector Number address fields in an LBA48 addressing scheme.

FIG. 5 is a flow diagram of an exemplary method 500 of processing an ATA payload. The method 500 may be performed in a processing element that comprises hardware, software, or firmware, or any combination of hardware, software, and firmware. For example, the method 500 may be performed by firmware running in the bridge 110. The method 500 includes the actions described below.

The method 500 includes receiving, in an action 502, an information payload from a first bus. For example, in the exemplary system 100, the bridge 110 may receive a USB-compatible information payload from the USB interface 104. The USB-compatible information payload may comprise a SCSI CBW, for example the CBW 200. The CBW 200 may include a header portion 202 and a payload portion 204. The payload portion 204 may comprise a CBWCB, which further comprises the opcode 212, the control field 214, and other bytes 216. The other bytes may include an ATA command payload, for example the ATA command payload 412. The opcode may define a custom SCSI command. The opcode could be, for example, 0×F0, and the custom SCSI command may cause an ATA command to be “passed through” a USB interface—with substantially no change to the ATA command itself.

The method 500 further includes processing, in an action 504, the information payload. For example, the bridge 110 may extract the CBWCB 204 from the CBW 200. The bridge 110 may subsequently extract the ATA command payload 412 from the CBWCB 204.

The method 500 further includes sending, in an action 506, the information payload over a second bus. For example, the bridge 110 may send the extracted ATA command payload 412 to the ATA device 108, via the ATA interface 114.

Although the exemplary embodiments illustrated in FIG. 1 and described in this disclosure include a bridge integrated with an ATA device, other implementations are possible. For example, the bridge may be integrated with a USB device in a single product. In other embodiments, the bridge may be a stand-alone device. Various embodiments may include a number of ports for connecting to one or more ATA devices and/or one or more USB devices. The bridge may provide routing capabilities for routing information payloads between selected devices, and processing the information payloads according to the type of bus corresponding to the selected devices. Moreover, some embodiments may include a bridge that processes information packets between buses other than USB and ATA. For example, other interfaces that use SCSI protocols may use the methods described herein.

A universal serial bus (USB) is one type of communication interface that may be used to connect two or more processor-based devices. For example, a USB interface may be used to connect a computer device to a printer or to a digital camera.

Devices with USB interfaces (“USB devices”) are generally easy for users to configure and operate. For example, USB memory devices may provide users with a small form-factor storage medium that may operate without requiring hardware or software configuration. Users may utilize such USB memory devices to store, retrieve, and transport data between different computer devices.

A small computer system interface (SCSI) is another type of communication interface. A SCSI interface may be used to connect a computer device to certain types of mass storage devices such as, for example, hard disc drives (HDDs), compact disc read-only memory (CD-ROM) devices, tape drives, or to certain peripherals, such as, for example, scanners. Certain USB memory devices may use SCSI protocols and commands.

An advanced technology attachment (ATA) interface is another type of communication interface. In some implementations, an ATA interface may be used to connect a computer device to a mass storage device, such as, for example, an HDD or a CD-ROM device. Many documents that characterize various aspects of ATA interfaces have been published by the American National Standards Institute (ANSI). These documents may be publicly available for purchase at http://www.techstreet.com. “ATA” may refer to many similar interfaces. “ATA” or “ATA-1” may be commonly referred to as an “Integrated Drive Electronics” (IDE) interface. IDE may technically refer to any hard disc drive with an integrated controller, but many may use “IDE” to refer generally to devices that include an ATA interface. Other variations of ATA may be characterized. For example, ATA-2 may refer to an interface with higher data speed transfer modes than ATA-1. Some may refer to ATA-2 as “Extended IDE” (EIDE). ATA-3 may refer to an interface with additional features. For example, an ATA-3 interface may characterize integrated diagnostic features that may provide early warnings of possible drive failure. These diagnostic features may monitor changes in HDD parameters, such as drive temperature, time required for a HDD platter to reach a certain speed, distance above a platter at which a head operates, frequency with which particular sectors are internally identified as defective, or other parameters. Changes in these parameters may enable prediction of certain kinds of HDD failures. This technology may be referred to as Self-Monitoring Analysis and Reporting Technology (SMART) and it is described in documents covering ATA-3 and subsequent versions of ATA. ATA/ATAPI-4 (ATA Packet Interface) may refer to another ATA interface that supports new features and new devices, such as, for example, CD-ROMs or tape interfaces. ATA/ATAPI-5 may refer to another ATA interface. ATA/ATAPI-6 may characterize an interface that supports larger “addresses” with which data may be indexed on a HDD. For example, an ATA/ATAPI-6 interface may include 48-bits to comprise a logical block address (LBA). Serial ATA (SATA) may characterize a serial interface that shares many protocols and commands with other ATA interfaces. Other documents that characterize interfaces built on “ATA” may also exist, and others may be developed in the future.

ATA interfaces may be widely used to connect a computer device to a mass storage device such as a HDD, CD-ROM or other storage media. USB interfaces may be widely used to connect a computer device to a peripheral device, including to a peripheral storage device.

In other implementations, embodiments may be used to process a packet of information in a bridge between a bus and one of the following types of busses: Institute of Electrical and Electronics Engineers (IEEE) 1394 serial bus, a Serial Attached SCSI (SAS) bus, and an Internet SCSI (iSCSI) bus.

Embodiments may be implemented, at least in part, in hardware or software or in any combination thereof. Hardware may include, for example, analog, digital, or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

A number of embodiments have been described. Nevertheless, it will be understood that various modifications may be made without departing from the spirit and scope of this disclosure. For example, embodiments may be applied to communication interfaces that will be developed in the future. Accordingly, other embodiments are within the scope of the following claims.

What is claimed is:

1. In a bridge between a first bus and a second bus, a method of processing a packet of information, the method comprising:
receiving the packet of information from the first bus, the packet of information comprising a wrapper, an opcode, and an information payload, the information payload having more than ten bytes and being in a format compatible with the second bus;
separating the wrapper from the information payload and identifying the opcode; and
sending the information payload over the second bus without substantial alteration when the identified opcode is a predetermined opcode.

2. The method of claim 1, wherein the first bus is a universal serial bus (USB).

3. The method of claim 1, wherein the packet of information complies with a USB bulk-only transport protocol.

4. The method of claim 1, wherein the second bus is an advanced technology attachment (ATA) bus.

5. The method of claim 1, wherein the first bus is selected from a group consisting of: an Institute of Electrical and Electronics Engineers (IEEE) 1394 serial bus, a Serial Attached SCSI (SAS) bus, and an Internet SCSI (iSCSI) bus.

6. A bridge to process a packet of information between a first bus and a second bus, the bridge comprising:
a first data interface that receives the packet of information from the first bus, the packet of information comprising a wrapper, an opcode, and an information payload, the information payload having more than ten bytes and being in a format compatible with the second bus;
a processing element that separates the wrapper from the information payload and identifies the opcode; and
a second data interface that sends the information payload over the second bus without substantial alteration when the identified opcode is a predetermined opcode.

7. The bridge of claim 6, wherein the first bus is a universal serial bus (USB).

8. The bridge of claim 6, wherein the packet of information complies with a USB bulk-only transport protocol.

9. The bridge of claim 6, wherein the second bus is an advanced technology attachment (ATA) bus.

10. The bridge of claim 6, wherein the first bus is selected from a group consisting of: an Institute of Electrical and Electronics Engineers (IEEE) 1394 serial bus, a Serial Attached SCSI (SAS) bus, and an Internet SCSI (iSCSI) bus.

11. A bridge that couples a universal serial bus (USB) and an advanced technology attachment (ATA) bus, the bridge comprising:
a USB interface that transfers data in a USB-compatible format between the bridge and the USB;
an ATA interface that transfers data in an ATA-compatible format between the bridge and the ATA bus; and
a processing element that converts data between the USB-compatible format and the ATA-compatible format,
wherein the data in the USB-compatible format comprises a first portion and a second portion, the second portion comprising more than ten bytes in length, and
wherein the processing element converts data in the USB-compatible format to the ATA-compatible format by sending the second portion over the ATA bus without substantial alteration.

12. The bridge of claim 11, wherein the second portion substantially complies in format with a small computer system interface (SCSI) transparent command set specification and includes an opcode.

13. The bridge of claim 12, wherein the second portion comprises an ATA command and a SCSI wrapper.

14. The bridge of claim 13, wherein the opcode specifies an ATA pass-through function to remove the SCSI-command wrapper from the ATA command with substantially no change to the ATA command.

15. The bridge of claim 13, wherein the ATA command comprises a Self-Monitoring, Analysis and Reporting Technology (SMART) command.

16. The bridge of claim 13, wherein the ATA command comprises a logical block address.

17. The bridge of claim 16, wherein the logical block address comprises 48 or more bits.

18. A computer program product tangibly embodied in an information carrier, the computer program product containing instructions that, when executed, cause a processor to perform operations to process a packet of information in a bridge between a first bus and a second bus, the operations comprising:
receiving the packet of information from the first bus, the packet of information comprising a wrapper, an opcode, and an information payload, the information payload having more than ten bytes and being in a format compatible with the second bus;
separating the wrapper from the information payload and identifying the opcode; and
sending the information payload over the second bus without substantial alteration when the identified opcode is a predetermined opcode.

19. The computer program product of claim 18, wherein the first bus is a universal serial bus (USB), and the second bus is an advanced technology attachment (ATA) bus.

20. The computer program product of claim 18, wherein the packet of information complies with a USB bulk-only transport protocol.
